(19) United States
(12) Patent Application Publication
(10) Pub. No.: US 2009/0307489 A1
(43) Pub. Date: Dec. 10, 2009

(54) Mobile Communication Equipment and Method of Controlling Same

(75) Inventor: Takashi Endoh, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/162,468

(22) PCT Filed: Jan. 25, 2007
(86) PCT No.: PCT/JP2007/051175

§ 371 Date: Nov. 24, 2008

(30) Foreign Application Priority Data
Jan. 30, 2006 (JP) 2006-020418

(51) Int. Cl. H04L 9/00

(52) U.S. Cl. 713/168

(57) ABSTRACT

The present invention provides mobile communication equipment (10) having a communicating unit (11) for communicating with a server and interface units (13, 14) removably connected to a storage unit (12) provided with an unique media ID, wherein the mobile communication equipment includes a controlling unit (15) for controlling the communicating unit and the storage unit so as to communicate with the server using the communicating unit; transmit the media ID which is unique to the storage unit and obtained from the storage unit via the interface unit and a content ID corresponding to an encrypted content to the server; receive unique information which is unique to the content ID and the media ID and necessary for decrypting the encrypted content not to be stored in the mobile communication equipment from the server; and store the unique information in the storage unit via the interface unit.

### TECHNICAL FIELD

The present invention relates to mobile communication equipment and a method of controlling such equipment, and in particular to mobile communication equipment capable of associating encrypted content managed by a predetermined system with a media managed by a predetermined system to decrypt the encrypted content and a method of controlling such equipment.

### RELATED ART

Conventionally, there are known a device and a method of playing moving image information and perform even editing on mobile communication equipment such a mobile phone (refer to Patent Document 1). These conventional device and method are capable of editing moving images even on equipment with limited computing capability such as mobile communication equipment. In addition, there is conventionally known a management system in which user can view moving image information, however, cannot play and view an unauthorized duplicate. Further, there is conventionally known a management system as described below, in which user can record moving image information on an authorized recordable media and play as well as view the information, however, cannot play and view an unauthorized duplicate. Advanced Access Content System (AACS) Recordable Video Book, Revision 0.90 Apr. 14, 2005 (Preliminary Draft) (refer to Non-Patent Document 1).

One of features in this conventional system is that in order to encrypt a key for decrypting the encrypted moving image information (encrypted information) and to decrypt the encrypted key, a device key, a media ID and record information all of which are supplied by the predetermined management system (organization) need to be authentic. In other words, required are a player (playing device) provided with a device key approved by a predetermined management system, a media provided with a media ID approved by the predetermined management system, and record information approved by the predetermined management system and recorded on the media. This management system manages the device key so as not to be leaked and is designed to be capable of revoking the device key in a case where the device key is leaked. Further, the media ID is managed with a method impossible to be duplicated, so that even if the encrypted information is duplicated, playing is still impossible. FIG. 7 shows how the player plays contents recorded on the recordable media according to the conventional system. A MKB (Media Key Block), a media ID, a MAC (Message Authentication Code) value, random numbers at the time of binding (Binding Nonce), an encrypted title key, a usage rule, a MAC value of the usage rule and a encrypted content are recorded on the recordable media and are presented to the player. The player derives the media key from the MKB using the device key; processes the media key by means of the random numbers at the time of binding; and decrypts the title key using the processed media key. The player further generates a MAC value using the processed title key and determines whether or not the resultant MAC value key coincides with one presented. When they coincident with each other, the player decrypts and plays the moving image information using the title key.

Additionally, the conventional management system employs an approach in which the encrypted information is distributed via a network and is bound to a managed recordable media, thereby being playable. In executing this binding, record playing equipment accesses an information exchange server (a clearing house) 554 and transmits the content ID, the media ID and the random numbers at the time of binding, and then, obtains the title key for decrypting the encrypted information with the title key encrypted. The player decrypts the media key using the device key, and decrypts the title key using the media ID and the random numbers at the time of binding, and thereafter, decrypts the encrypted information. FIG. 8 shows this conventional system. A client 551 as a player is equipped with a recordable optical disk media 552 managed by the predetermined system. The client 551 communicates with a content server 553 via the network, and purchases the content to obtain a proof of purchase (ticket). Further, the client 551 downloads the encrypted moving image information and records the information on the media 552. Thereafter, the client 551 communicates with the information exchange server 554, and transmits the proof of purchase, the media ID, the random numbers at the time of binding and the like to the information exchange server 554. When the information exchange server 554 confirms that this procedure is correct, the server 554 returns the key for decrypting the encrypted information with the key encrypted such that only the media can obtain the key. This information is recorded on the media 552, and the binding completes.

Patent Document 1: Japanese Patent Application Laid-open No. 2005-51307

Non-Patent Document 1: Web-sate; http://www.aacsla.com/home

### DISCLOSURE OF THE INVENTION

### Problems to be Solved by the Invention

A record playing device according to the conventional management system has a problem that the device needed to be connected from a home network via the Internet to an information exchange server for a binding process, and configuration of a network for realizing this requires knowledge on the network. For example, the knowledge on DHCP (Dynamic Host Configuration Protocol), NAT (Network Address Translation), a firewall and the like is required. Additionally, some homes have a problem that they might not be connected to an Internet provider. In other words, for the purpose of the binding process that was preprocessing for playing encrypted contents, a player is required to include a settlement function and a communication function, which exhibits inconvenience.

The content needs to be purchased before the binding, and personal information is required to be input so as to be capable of processing a settlement via the network, or has to be stored in the player, which exhibited inconvenience. In addition, for increasing sales of the contents, a system in which the user can easily make a purchase contract is preferred. However, the record playing device of the conventional management system is fixedly connected to a display device such as a television, and accordingly, specific billing and/or settlement unit are hard to be provided thereto, and further, the user has limited time for viewing the advertisement.

Meanwhile, mobile communication equipment as represented by a mobile phone is provided with an Internet connection function, and can be easily arranged to include the settlement function. It is advantageous, when such equipment is carried along at all times, to distribute advertisements. Therefore, the mobile communication equipment is desirably designed such that the moving image information can be purchased by means of the mobile communication equipment. However, there is a problem that a vast amount of storage is required to record the moving image information, and accordingly, the information cannot be recorded in the mobile equipment. Consequently, in order to decrypt (allow the playing of) the encrypted content and the like stored in the player in the home, it is an object of the present invention to provide a scheme in which the process of purchasing the content is performed at the mobile communication equipment side and the binding process is performed in a storage device (such as a SD card connected to the aforementioned equipment, and on the basis of the information of the mobile communication equipment which has been already subjected to the binding process (in the present specification, referred to as unique information), the encrypted content can be played by the player in a home or an office under the supervision of this mobile communication equipment.

### Means for Solving the Problem

In order to solve the above-mentioned various problems, mobile communication equipment according to the present invention having a first communicating unit for communicating with a server connected to a network via a communication path (typically a communication channel on wireless communication) and an interface unit removably connected to a storage unit provided with an unique media ID (i.e., a connector connected to the storage unit for exchanging information) comprising
a controlling unit for controlling the first communicating unit and the storage unit so as to (communicate with the server using the first communication unit to obtain and purchase a content ID corresponding to an encrypted content and further) communicate with the server using the first communicating unit; transmit the media ID which is unique to the storage unit and obtained from the storage unit via the interface unit and the content ID corresponding to the purchased encrypted content to the server; receive unique information which is unique to the content ID and the media ID and necessary for decrypting the encrypted content not to be stored in the mobile communication equipment from the server; and store the unique information in the storage unit via the interface unit.

In accordance with another embodiment, the mobile communication equipment further comprises a second communicating unit for communicating with a playing device for playing the encrypted content, wherein the controlling unit controls the second communicating unit and the storage unit such that when the mobile communication equipment receives a request for decrypting encrypted content via the second communicating unit, the mobile communication equipment searches the unique information corresponding to the encrypted content in the storage unit via the interface unit, and, in the event of finding the corresponding unique information, the mobile communication equipment reads out the unique information and transmits the unique information to the playing device.

Additionally, in accordance with further embodiment, the mobile communication equipment further comprises a presentation unit (a display, a speaker or the like) for presenting information (e.g., a content name, the content ID, a name of a content producer and the like) on the encrypted content corresponding to the unique information in the event that the mobile communication equipment searches the storage unit and finds the corresponding unique information therein, and an operating unit for inputting playing permission of the corresponding encrypted content, wherein the controlling unit controls the second communicating unit so as to transmit the corresponding unique information only when the playing permission is input from the operating unit.

Further, in accordance with yet another embodiment, the mobile communication equipment further comprises a presentation unit for presenting information (e.g., the content name, a list of the content ID(s), a list of content viewing and the like) on the encrypted content received via the second communicating unit and an operating unit for selecting the encrypted content to be purchased from the presented information.

Furthermore, in accordance with still another embodiment, the mobile communication equipment further comprises a broadcast receiving unit, a presentation unit for presenting information on the encrypted content (e.g., an advertisement included in a terrestrial digital broadcast, the content name, the list of the content ID(s), the list of the content viewing or the like) received via the broadcast receiving unit, and an operating unit for selecting the encrypted content to be purchased from the presented information.

In the above, the means for solving the above-mentioned problems of the present invention has been explained as a device. However, the present invention can be realized also as a method, a program and a storage medium recording the program which substantially correspond to these means, and therefore, it should be appreciated that these shall be included in the scope of the present invention. For example, a method for controlling mobile communication equipment according to another embodiment, which has realized the present invention as a method, including a communicating unit for communicating with a server connected to a network via a communication path and an interface unit removably connected to a storage unit provided with an unique media ID, comprises the steps of: communicating with the server using the communicating unit; transmitting the media ID which is unique to the storage unit and obtained from the storage unit via the interface unit and a content ID corresponding to a purchased and encrypted content to the server; receiving unique information which is unique to the content ID and the media ID and necessary for decrypting the encrypted content, from the server; and storing the unique information in the storage unit via the interface unit. cl Effect of the Invention

According to the present invention, in order to attach the storage unit provided with the unique media ID managed by a predetermined system to the interface unit and obtain the playing permission of the content managed by the predetermined system, it is possible to communicate with the information exchange server using a network function of the mobile communication equipment, and to obtain the unique information necessary for decrypting the encrypted information (content) not to be stored in the mobile communication equipment to store the information. This enables the purchase, settlement and binding processes of the content for of playing the content on an external player by means of the mobile communication equipment, and allows convenience of the user to be improved while protecting the right of an owner of copyright. In other words, the user can secure more flexible settlement and viewing environments.

### BRIEF DESCRIPTION OF THE DRAWINGS

FIG. 1 is a block diagram of mobile communication equipment according to a first embodiment of the present invention.

FIG. 2 is a flow chart showing operation of the mobile communication equipment according to the first embodiment of the present invention.

FIG. 3 is a block diagram of mobile communication equipment according to a second embodiment of the present invention.

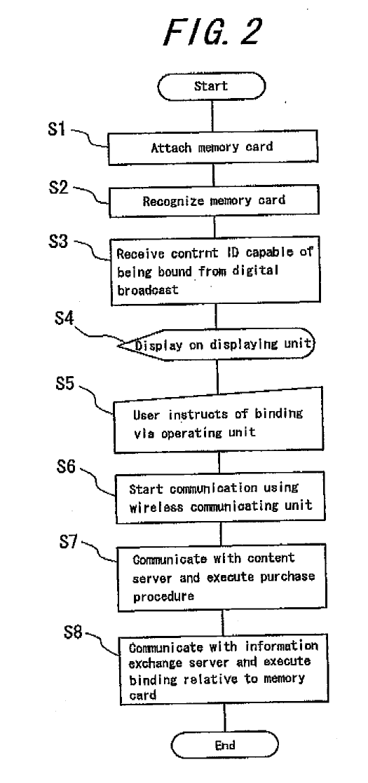

FIG. 2 is a flow chart showing operation of the mobile communication equipment according to the first embodiment of the present invention.

FIG. 5 is a block diagram of mobile communication equipment according to a third embodiment of the present invention.

FIG. 6 is a flow chart showing operation of the mobile communication equipment according to the third embodiment of the present invention.

FIG. 7 is a view showing a process of a player playing content recorded on a recordable media in a conventional management method.

FIG. 8 is a view showing a process in which content is bound to a managed media to be downloaded via a network in the conventional management method.

### BEST MODE FOR CARRYING OUT THE INVENTION

Hereinafter, embodiments of the present invention will be discussed in detail with reference to attached figures.

### First Embodiment

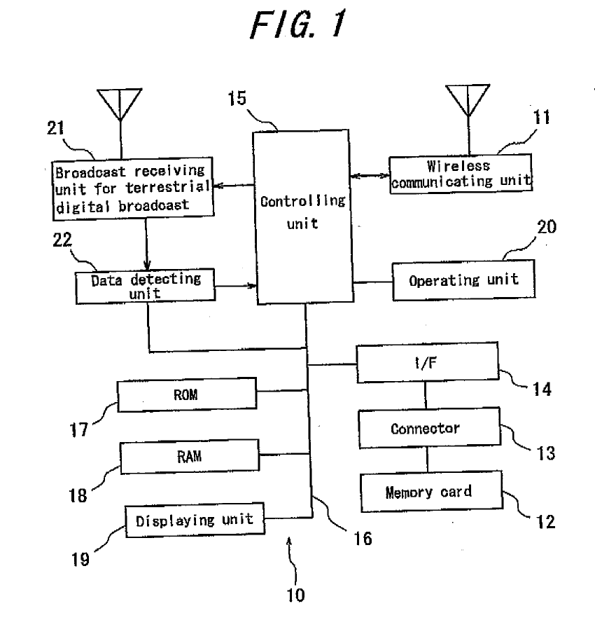

FIG. 1 is a block diagram of a first embodiment according to the present invention, and FIG. 2 is a flow chart thereof. As shown in FIG. 1, mobile communication equipment 10 (a mobile phone, for typical example) has a wireless communication unit 11 which utilizes a data communicating device in a mobile phone network and enables the equipment to communicate with a server connected to the Internet. A memory card 12 stores a media ID managed by a predetermined system in such a manner that the ID can be duplicated. This system may be equipped with, for example, a controlling unit (CPU, processor and the like) in the memory card, communicate with an external instrument according to a predetermined protocol, and prohibit a direct access to a memory in the memory card 12 from the outside. The memory card 12 is removably connected to a body by a connector 13. An interface unit 14 including I/F (Interface) LSI is connected to the connector 13, which realizes transmission and reception of data with the memory card 12 and connect to a bus 16 of the present equipment to be able to read and write data. The present equipment also includes a controlling unit 15, a ROM 17, a RAM 18, and a displaying unit 19, each of which being connected to the bus 16, as is the case with general mobile communication equipment. In addition, the equipment includes an operating unit 20 operable with buttons or the like which is connected to a key interface of the controlling unit 15.

Further, the equipment includes a broadcast receiving unit 21 for a terrestrial digital broadcast and a data detecting unit 22. The broadcast receiving unit 21 is operated by an instruction from the controlling unit 15; receives a broadcast wave by way of RF and IF circuits; performs channel select process, OFDM process, demodulation process and error-correcting process; and outputs a TS (Transport Stream). The data detecting unit 22 detects data multiplexed in the TS, and notifies the controlling unit 15 of interruption. The controlling unit 15 supplies the detected data to a predetermined processing unit via the bus 16. For example, the data is accumulated in the RAM 18, and corresponding software processes the accumulated data.

When an advertisement informing that the content can be purchased and bound is inserted during a broadcast, the advertisement is inserted as one portion of a data broadcast. The data broadcast is processed by software in the equipment, and displayed on the displaying unit 19. The mobile communication equipment of the present embodiment uses a content ID informed by the advertisement to perform the binding.

Next, explained will be an operation of the mobile communication equipment according to the embodiment shown in FIG. 1 with reference to the flow chart in FIG. 2. In this flow chart, the servers are a content server 553 and an information exchange server 554 each being shown in FIG. 8 as the conventional technology, and the same applies to respective embodiments to be explained later. In the beginning of processes in FIG. 2, the controlling unit 15 executes Processing S1. The process S1 is to attach the memory card 12 managed by a predetermined management system into the connector 13 included in the equipment. Next, the step moves to the process S2. In the process S2, the present equipment recognizes the memory card 12. First, the interface unit 14 detects the memory card 12 and electronically confirms its operation, a test is, then, executed whether the memory card is a proper device or not to be managed by the predetermined management system. When the test determines that they are mutually compatible devices, the memory card starts to accept read and write requests from the controlling unit 15 via the bus 16, and the equipment recognizes the memory card 12. Then, the step moves to the process S3.

The process S3 is to receive the content ID capable of being purchased and bound from the advertisement of the terrestrial digital broadcast. This advertisement is inserted in the middle of the data broadcast as mentioned above, and is processed to be recognized by software of a data broadcast browser. The step, then, moves to process S4. The process S4 is to display the advertisement on the displaying unit 19. The displaying unit displays a title of the content, the notice that the purchase and the binding are possible, and choices on whether to purchase the content or not (contents list). Next, the step moves to process S5. The process S5 is to wait for button operation. The step moves to process S6 when a user instructs of the purchase and the binding via the operating unit serving as a selecting unit. When the user instructs not to purchase the content, the advertisement on a display screen is erased and the screen returns to the state before the advertisement is displayed thereon. The process S6 is to start an internet connection using a wireless communicating unit. The step, then, moves to process S7. The process S7 is to communicate with the content server 553 and execute a purchase procedure of the content of the received content ID. The displaying unit 19 displays a purchase detail including a purchase price and a settlement method, and the user is requested to approve it. When the user approve it, the settlement is executed, and the content server 553 returns proof of purchase (ticket). The step, then, moves to process S8.

The process S8 is to communicate with the content server 554; execute a binding process; and write its result in the memory card 12. At the time of the binding, information sent to the information exchange server 554 from the present equipment includes the proof of purchase, the media ID, random numbers at the time of binding, and others. The information exchange server 554 extracts information on the content ID from a database, and complements the information necessary for the binding. The information exchange server 554 returns MAC value and an encrypted title key. The memory card 12 stores the content ID, the media ID, the random numbers at the time of binding, the MAC value, and the encrypted title key. This flow chart ends with this.

As described above, according to the present embodiment, in the wake of the advertisement broadcasted during the terrestrial digital broadcast, the content ID included in the advertisement can be obtained, and the purchase and the binding of the content can be easily and rapidly performed. When the memory card in which the binding has completed is taken out and attached to a player, a code of the content can be decrypted, which allows to play the content. It is noted that encrypted information (content) is not stored in the mobile communication equipment of the present embodiment, so that the information needs to be stored in a storage device that the player (playing device) can access. This storage device may be a hard disk in the player, a storage device capable of being accessed via a home network, or, further, the content server 553 capable of being accessed via the Internet.

### Second Embodiment

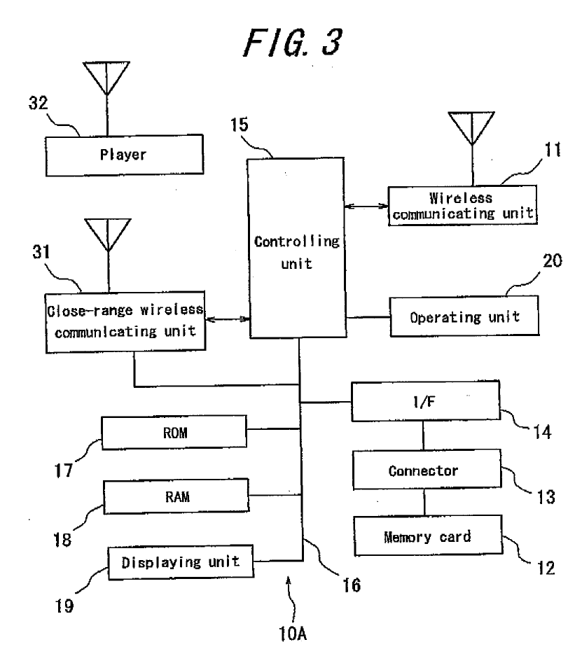

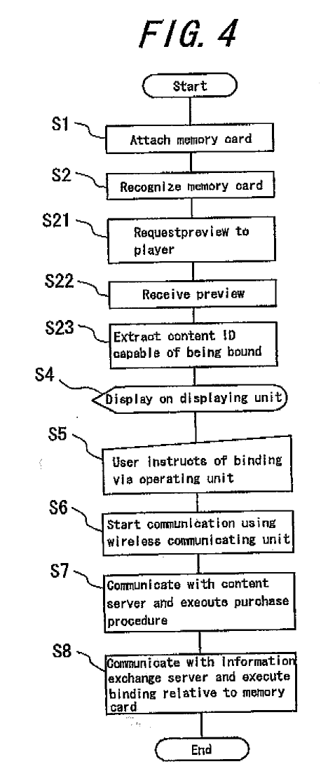

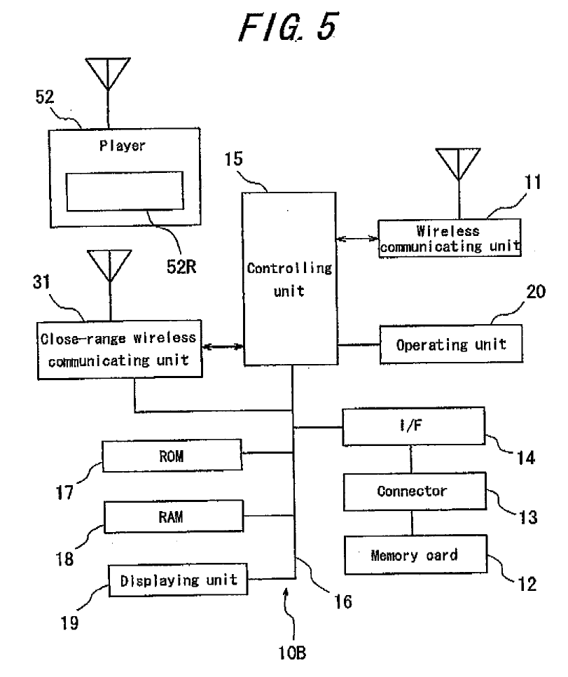

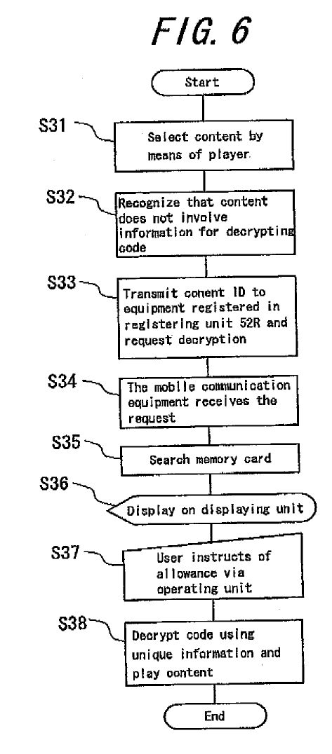

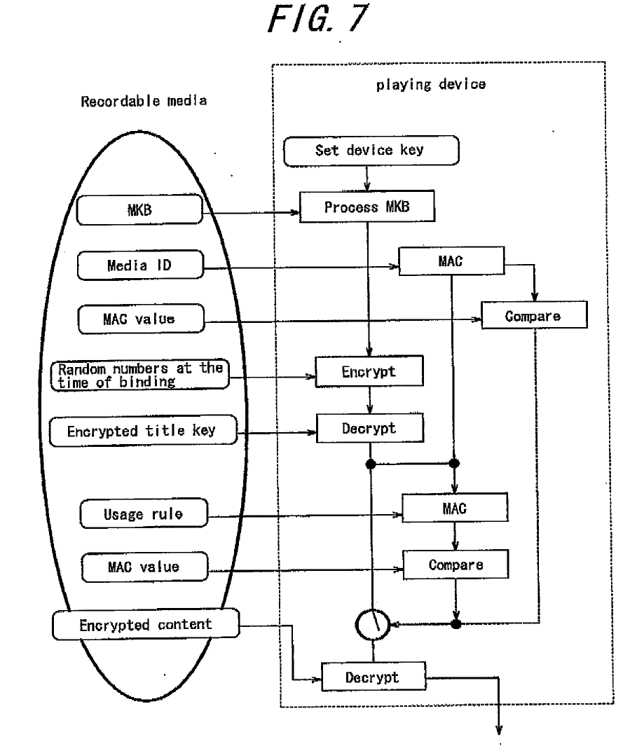

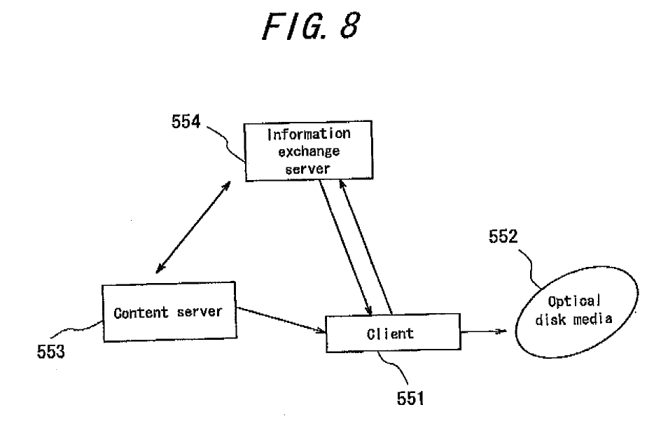

FIG. 3 is a block diagram showing a second embodiment of the present invention, and FIG. 4 is a flow chart showing its operation. In this embodiment, mobile communication equipment 10A has a close-range wireless communicating unit 31, and communicates with a player 32 also having a close-range wireless communicating unit. As a close-range wireless communication, for example, a wireless LAN such as IEEE 802.15.1 or IEEE 802.11g, wireless IEEE 1394 or infrared data communication may be used. Noted that other components included in the mobile communication equipment 10A are same as those described with reference to the first embodiment, and therefore, explanation of the same components will be omitted. The mobile communication equipment of this embodiment communicates with the player 32, and requests the player 32 for a preview (a view without charge). The preview is a moving image having a small size, for example, 320 pixels by 180 pixels which is suitable for being viewed on mobile equipment. When a media in which encrypted moving image information has been recorded is inserted into the player 32, or, when the moving image information is selected via the home network, the moving image in a main story cannot be decrypted and viewed as far as the information is unbound, however, it is possible to view the preview. This is because the preview is recorded without being encrypted in order to prompt the user to purchase the content. Additionally, even when the media is already bound, the preview can be stored for an advertisement of another content. The content includes the advertisement of the content capable of being purchased and bound. When the mobile communication equipment of the embodiment obtains the preview from the player 32, the equipment detects the advertisement included therein. The advertisement includes the content ID, and the ID is used to allow the binding.

FIG. 4 is a flow chart showing an operation of the second embodiment. FIG. 4 is generally same as FIG. 2, so that explanation will be done with a focus on the steps having difference. The step moves to process S21 following the process S2. The process S21 is to request the preview to the payer 32 capable of being communicated with via the close-range wireless communicating unit 31 through operation by the user. Next, the step moves to process S22. The process S22 is to receive the preview transmitted from the player 32, and thereafter, store the preview in the RAM 18. Alternatively, the preview can also be stored in another unillustrated storage unit such as a small hard disk in place of the RAM 18. Next, the step moves to the process S23. The process S23 is to inspect the received preview and recognize the advertisement included therein, and thereafter, extract the content ID capable of being purchased and bound included in the advertisement. Next, the step moves to the process S4. The steps following S4 are same as those in FIG. 2.

### Third Embodiment

FIG. 5 is a block diagram showing a third embodiment of the present invention, and FIG. 6 is a flow chart showing its operation. In FIG. 5, mobile communication equipment 10B includes a player 52 provided with a registering unit 52R, and the registering unit 52R stores information on accessing the mobile communication equipment 10B of the present invention via a close-range wireless network. The player 52 transmits a decryption request (request for playing permission) to equipment registered in the registering unit 52R, if necessary. However, other components of the mobile communication equipment in FIG. 5 are same as those in FIG. 3, and features of the present embodiment are found in FIG. 6.

In the beginning of processes in FIG. 6, the controlling unit 15 executes the process S31. The process S31 is to select the content by means of the player 52. The content includes encrypted information, and may be selected the information through, for example, an optical disk on which the content has been recorded and which is inserted into the player 52, or the content may be selected through a connection with the server accessed via the home network or the internet. Next, the step moves to the process S32. The process S32 is to inspect whether the selected content involves unique information for decrypting the code and recognize that the content dose not involve the unique information. Such case occurs when the unbound media is inserted into the player 52, or, when the user accesses the server that supplies the unbound content. Next, the step moves to the process S33.

In the process S23, the player 52 starts communication with the equipment registered in the registering unit 52R; transmits the content ID to the equipment; and requests decryption thereto. At this time, the mobile communication equipment of the present invention has been recorded in the registering unit 52R, so that the player 52 starts the communication via the close-range wireless communication. Next, the step moves to the process S34. In the process S34, the mobile communication equipment receives the content ID and decryption request via the close-range wireless communication unit 31. Next the step moves to the process S35. In he process S35, the mobile communication equipment searches the memory card 12 and inspects whether the memory card has stored the unique information corresponding to the requested content ID. The memory card 12 may be a single card or plural cards, or further, one card may be theoretically divided into plural partitions. However, the media ID in accordance with a predetermined management system needs to be recorded on the memory card 12 per a partition and per a card. As a result of the search process, when the corresponding unique information exists, the step next moves to the display process S36.

In the display process S36, the mobile communication equipment displays, on the displaying unit 19, the fact that the player 52 is now requesting “playing permission” of certain content and the options whether the user will allow the playing, and prompts the user to select the option. Next, the step moves to the process S37. In the process S37, the user operates the buttons on the operating unit 20 serving as a selecting unit to select the option and, instructs to allow the playing. Next, the step moves to the process S38. In the process S38, the mobile communication equipment and the player 52 cooperatively decrypt the title key by using the found unique information stored in the memory card, and the player 52 plays the content. At this time, information that must not be leaked is communicated on a close-range wireless communication path, so that he cryptographically secured information is communicated. The unique information necessary for decryption may be transmitted to the player 52 to allow the title key to be decrypted by the player 52, or the player 52 may transmit a media key to the mobile communication equipment and the equipment may decrypt the title key, and then, transmit the key to the player 52.

Although the present invention has been explained with reference to the various drawings and embodiments, it is to be noted that a person skilled in the art could easily make various modifications or changes on the basis of this disclosure. Therefore, it is also to be noted that these modifications or changes fall within the scope of the present invention. In the embodiments, the close-range wireless communication mechanism is cited as a communication mechanism with the player. However, this is merely an exemplification, and the communication unit may be the wireless communication unit employing a wireless frequency band normally used in a middle range or a long-range communication. Additionally, the memory card storing the unique information to which the binding process has been completed may be accommodated in and connected to the player body, and the encrypted content may be played. Further, in the embodiments, although the buttons indicative of alphameric characters, symbols are cited as a specific example of the operating unit, it is possible to use an audio-input unit such as a keyboard, a mouse, or a microphone. Furthermore, as a presentation unit, it is possible to use an audio-output mechanism such as a speaker or a vibration unit such as a vibrator, as well as the displaying unit such as the display.

The present application claims the benefit of a priority from Japanese Patent Application No. 2006-020418 (filed on Jan. 30, 2006), and its entire content has been incorporated in the specification of the present application by reference.

1. Mobile communication equipment having a first communicating unit for communicating with a server connected to a network via a communication path and an interface unit removably connected to a storage unit provided with an unique media ID, said equipment comprising
a controlling unit for controlling the first communicating unit and the storage unit so as to communicate with the server using the first communicating unit; transmit the media ID which is unique to the storage unit and obtained from the storage unit via the interface unit and a content ID corresponding to encrypted content to the server; receive unique information which is unique to the content ID and the media ID and necessary for decrypting the encrypted content not having been stored in the mobile communication equipment from the server; and store the unique information in the storage unit via the interface unit.

2. The mobile communication equipment according to claim 1, further comprising a second communicating unit for communicating with a playing device for playing the encrypted content, wherein the controlling unit controls the second communicating unit and the storage unit such that when the mobile communication equipment receives a request for decrypting encrypted content via the second communicating unit, the mobile communication equipment searches the unique information corresponding to the encrypted content in the storage unit via the interface unit, and, in the event of finding the corresponding unique information, the mobile communication equipment reads out the unique information and transmits the unique information to the playing device.

3. The mobile communication equipment according to claim 2, further comprising a presentation unit for presenting information on the encrypted content corresponding to the unique information in the event that the mobile communication equipment searches the storage unit and finds the corresponding unique information, and an operating unit for inputting playing permission of the corresponding encrypted content, wherein the controlling unit controls the second communicating unit so as to transmit the corresponding unique information only when the playing permission is input from the operating unit.

4. The mobile communication equipment according to claim 2, further comprising a presentation unit for presenting information on the encrypted content received via the second communicating unit and an operating unit for selecting the encrypted content to be purchased from the presented information.

5. The mobile communication equipment according to claim 2, further comprising a broadcast receiving unit, a presentation unit for presenting information on the encrypted content received via the broadcast receiving unit, and an operating unit for selecting the encrypted content to be purchased from the presented information.

6. A method for controlling mobile communication equipment including a communicating unit for communicating with a server connected to a network via a communication path and an interface unit removably connected to a storage unit provided with a unique media ID comprising the steps of:
communicating with the server using the communicating unit; transmitting the media ID which is unique to the storage unit and obtained from the storage unit via the interface unit and a content ID corresponding to an encrypted content to the server; receiving unique information which is unique to the content ID and the media ID from the server and necessary for decrypting the encrypted content; and storing the unique information in the storage unit via the interface unit.
